(19) United States
(12) Patent Application Publication
(10) Pub. No.: US 2006/0290178 A1
(43) Pub. Date: Dec. 28, 2006

(54) Detachable seat and saddlebag

(76) Inventor: Alexander Wilhelm Desser, San Diego, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(21) Appl. No.: 11/168,020

(22) Filed: Jun. 27, 2005

(51) Int. Cl. B62J 1/18

(52) U.S. Cl. 297/214; 297/219.11; 280/288.4

(57) ABSTRACT

The present invention provides a detachable assembly to be mounted on a vehicle fender, for example on the rear fender of a motorcycle. In a preferred embodiment, the detachable assembly comprises a seat that is detachably mounted on the fender and a pair of saddlebags attached to the seat, wherein the seat comprises a seat pad, a base portion and one or more suction cups mounted to the base portion for releasably attaching the seat to the fender. In another embodiment, the seat is releasably attached to the assembly.

### FIELD OF THE INVENTION

The present invention is directed to auxiliary vehicle seat assemblies, and more particularly to detachable auxiliary motorcycle seat assemblies including saddlebags.

### BACKGROUND OF THE INVENTION

Motorcycle riding has become increasingly popular over the last 50 years. One problem encountered with many motorcycles concerns the availability of a single seat, wherein only one person may safely ride the motorcycle at a time. Auxiliary seats for mounting on a rear motorcycle fender have been developed to increase seating capacity. Such auxiliary seats may also be used with bicycles, mopeds, scooters and other vehicles.

Side saddlebags and other containers are frequently used in conjunction motorcycles and other vehicles having limited storage capabilities, to accommodate additional effects. Since most motorcycles are designed to be operated at high speeds, rigid housings or frameworks are generally used which are positively secured to the motorcycle by structures integrally mated with the motorcycle frame. One drawback of such a construction is that a permanent or semi-permanent framework is required to accommodate the containers. Apart from the inconvenience of mounting, the framework also adds a considerable amount of weight to the motorcycle. Further, with the packs removed, the framework is an obtrusive addition to the motorcycle.

U.S. Pat. No. 5,322,345 discloses a seat assembly that is releasably attached to the rear fender of a motorcycle. The seat assembly is attached to the rear fender using suction cups that are embedded in the base of the seat.

U.S. Pat. No. 4,974,765 teaches a seat and tank bag assembly that is releasably attached to a motorcycle via suction cups. In particular, the bag is attached to a base member via hinges to allow access to the gas cap.

U.S. Pat. No. 4,442,960 teaches a saddlebag assembly for removable attachment to a motorcycle fender. The saddlebag assembly is attached to the fender via hook and loop fasteners in combination with hooks that grip the fender.

In view of the above, there exists a need for a detachable seat and saddlebag assembly to be mounted on a vehicle fender, wherein the detachable assembly comprises a seat that is releasably mounted on the fender using suction cups and a pair of saddlebags attached to the seat via straps.

In view of the above, there further exists a need for a modular detachable assembly to be mounted on a vehicle fender, wherein the modular detachable assembly comprising a base portion configured to be releasably mounted on the fender using suction cups, an optional saddlebag assembly releasably attached to the base portion and an optional seat releasably attached to the base portion.

### SUMMARY OF THE INVENTION

The present invention involves a detachable seat and saddlebag assembly adapted to be mounted on a vehicle fender. The seat and saddlebag assembly preferably is comfortable, removable and light weight. According to a preferred embodiment, the detachable seat and saddlebag assembly is affixed to the vehicle fender using a plurality of suction cups. The assembly advantageously may be installed and removed without causing damage to the fender or requiring modification of the fender to receive the assembly.

One aspect of the present invention involves a detachable assembly to be mounted on a vehicle fender, for example on the rear fender of a motorcycle. The detachable assembly comprises a seat that is detachably mounted on the fender and a pair of saddlebags attached to the seat, wherein the seat comprises a seat pad, a base portion and one or more suction cups mounted to the base portion for releasably attaching the seat to the fender. The base portion is disposed within the seat such that the suction cups extend through apertures within a bottom surface of the seat.

According to a preferred implementation of the invention, the saddlebags are attached to the seat or base portion via straps such that hang down on either side of the fender. The straps preferably are formed from a single piece of material comprising a central portion and a pair of end portions, wherein each end portion is attached to a saddlebag, and the central portion is disposed within the seat between the seat pad and the base portion. The central portion may be fixedly attached to the seat to maintain correct alignment of the saddlebags with the seat. An inside surface of the straps preferably is coated with a non-abrasive, anti-scratch material such as comprises neoprene.

Another aspect of the present invention involves a modular detachable assembly to be mounted on a vehicle fender, the modular detachable assembly comprising a base portion configured to be releasably mounted on the fender, a saddlebag assembly releasably attached to the base portion and a seat releasably attached to the base portion. According to a preferred embodiment, the base portion is releasably attached to the fender using one or more suction cups. Alternatively, the base portion may comprise a magnet for providing releasable attachment of the seat to the fender. The base portion, saddlebag assembly and seat preferably are connected using hook and loop fasteners.

A further aspect of the present invention involves a detachable assembly to be mounted on a vehicle fender, the detachable assembly comprising a base portion configured to be mounted on the fender and a saddlebag assembly releasably attached to the base portion. This embodiment does not require the use of a seat. The base portion may be releasably attached to the fender using one or more suction cups. Alternatively, the base portion may comprise a magnet for providing releasable attachment to the fender. The base portion and saddlebag assembly preferably are connected using hook and loop fasteners.

An additional aspect of the present invention involves a modular detachable assembly to be mounted on a vehicle fender, wherein the modular detachable assembly comprises a base portion configured to be mounted on the fender, a saddlebag assembly releasably attached to the base portion and a storage pack releasably attached to the base portion. The base portion preferably is releasably attached to the fender using one or more suction cups, or alternatively, using a magnet. The base portion, saddlebag assembly and storage packs preferably are interconnected using hook and loop fasteners.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a perspective view of a detachable seat and saddlebag assembly mounted on top of a vehicle fender constructed in accordance with the principles of the present invention;

FIG. 2 is a cross-sectional view of the seat and saddlebag assembly of FIG. 1 taken along line 1A-1A;

FIG. 3 is a bottom view of the seat depicted in FIG. 1;

FIG. 4 is a cross-sectional view of an alternative seat and saddlebag assembly constructed in accordance with the principles of the present invention;

FIG. 5 is a cross-sectional view of a modular seat and saddlebag assembly constructed in accordance with the principles of the present invention;

FIG. 6 is a partially exploded view of the modular seat and saddlebag assembly of FIG. 5; and

FIG. 7 is a cross-sectional view of an alternative modular seat and saddlebag assembly constructed in accordance with the principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a seat and saddlebag assembly adapted to be mounted on a vehicle fender. The assembly may be installed and removed without causing damage to the fender or requiring modification of the fender to receive the assembly. The seat provides a means for transporting an additional passenger on the vehicle, whereas the saddlebags provide a means for transporting additional cargo. As would be understood by those of ordinary skill in the art, the removable seat and saddlebag assembly of the present invention may be adapted foe use with other two-wheel vehicles such as bicycles, scooters and mopeds, without departing from the scope of the present invention.

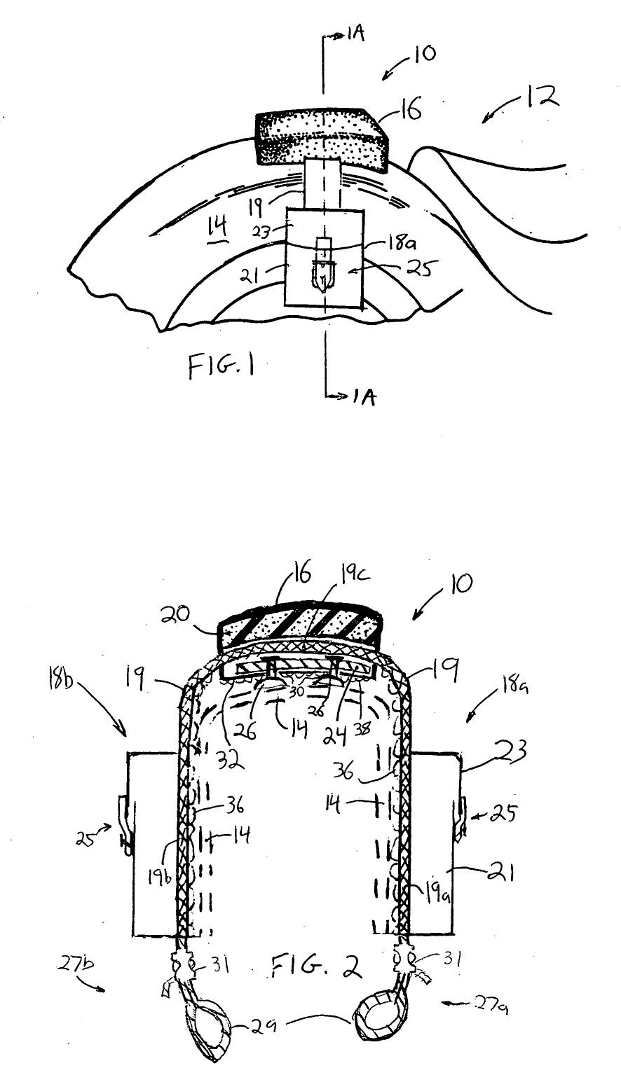

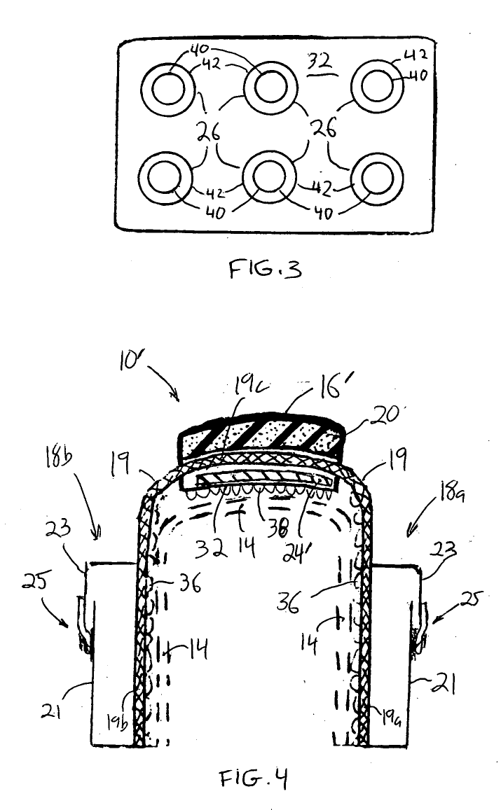

Referring to FIGS. 1 and 2, in accordance with the principles of the present invention, detachable assembly 10 is configured to be mounted on the rear fender 12 of motorcycle 14. The detachable assembly may also be mounted on the rear fender of a bicycle, scooter, moped or other vehicle. According to a preferred embodiment, detachable assembly 10 comprises seat 16 and a pair of saddlebags 18a, 18b. Seat 16 is releasably mounted on top of rear fender 12, whereas saddlebags 18a, 18b are attached to seat 16 via straps 19 such that hang down from seat 16 on either side of rear fender 12. Saddlebags 18a, 18b each comprise a main compartment 21 for storing cargo and a flexible flap 23 that is releasably attached to main compartment 21 via buckle assembly 25. Buttons or snaps may also be used for releasably attaching flaps 23 to the saddlebags.

In the illustrated embodiment, seat 16 comprises seat pad 20, base portion 24 and one or more suction cups 26 for attachment to rear fender 12. Seat 16 preferably is constructed of a moldable plastic or molded closed-cell, foam-like, composition for light weight and comfort. Base portion 24 is disposed within the seat such that suction cups 26 extend through apertures 30 within a bottom surface 32 of seat 16. Advantageously, base portion 24 provides structural support for the lightweight material used to manufacture seat pad 20. Base portion 24 further provides a foundation for mounting suction cups 26 thereto. The bottom surface of seat 16 preferably is contoured to substantially approximate the curvature of the rear fender.

With further reference to FIGS. 1 and 2, straps 19 may be formed from a single piece of material such as leather or nylon that is run through seat 16, such that end portions 19a, 19b of the material extend down from the seat on either side of fender 14. End portions 19a, 19b are attached to saddlebags 18a, 18b, respectfully, such that the saddlebags are oriented approximately parallel to one another on opposite sides of the fender. By way of example, end portions 19a, 19b may be sewn together with the saddlebags 18a, 18b, or alternatively, they may be attached with the saddlebags using an adhesive, releasable buttons, releasable snaps, or other suitable releasable or permanent connectors.

The central portion 19c of the single piece of strap material is preferably disposed between seat pad 20 and base portion 24. Central portion 19c may be sewn together with the seat to maintain correct alignment of the saddlebags with respect to the seat. Alternatively, the central portion may be sewn together with the seat. The inside surface of the strap material may be coated with a non-abrasive, anti-scratch layer 36. Similarly, bottom surface 32 of seat 16 may also be coated with a non-abrasive, anti-scratch layer 38. One suitable material for non-abrasive, anti-scratch layers 36, 38 is neoprene.

According to some embodiments of the invention, each saddlebag 18a, 18b is provided with an adjustable strap assembly 27a, 27b, respectfully for securing the saddlebags to the motorcycle frame. Specifically, each adjustable strap assembly may comprise an adjustable loop 29 that is releasably attached to the saddlebag via buckle 31. Adjustable strap assemblies 27a, 27b may be sewn together with the saddlebags 18a, 18b, or alternatively, they may be attached with the saddlebags using an adhesive, releasable buttons, releasable snaps, or other suitable releasable or permanent connectors.

Referring to FIG. 3, the bottom surface of seat 16 is depicted with suction cups 26 extending through the apertures in bottom surface 32, which is shown without anti-scratch layer 38 for illustrative purposes. Suction cups 26 preferably comprise double suction cups having an inner cup 40 disposed within the center of an outer cup 42, to provide improved gripping capabilities. In the illustrated embodiment, six double suction cups are provided in three rows of double cups along the length of seat 16. As would be appreciated by those of ordinary skill in the art, any number of suction cups and suction cup configurations may be utilized without departing from the scope of the invention.

Referring to FIG. 4, according to an alternative embodiment, detachable assembly 10′ comprises seat 16′ comprising seat pad 20 having base portion 24′ embedded therein. Base portion 24′ comprises a magnet for providing releasable attachment of the seat to the rear fender of the vehicle. Base portion 24′ also provides structural support for the lightweight material used to manufacture the seat pad. Bottom surface 32 of seat pad 20 is again provided with a non-abrasive, anti-scratch layer 38. The structure of saddlebags 18a, 18b including the straps is similar to that of the embodiment of FIGS. 1 and 2.

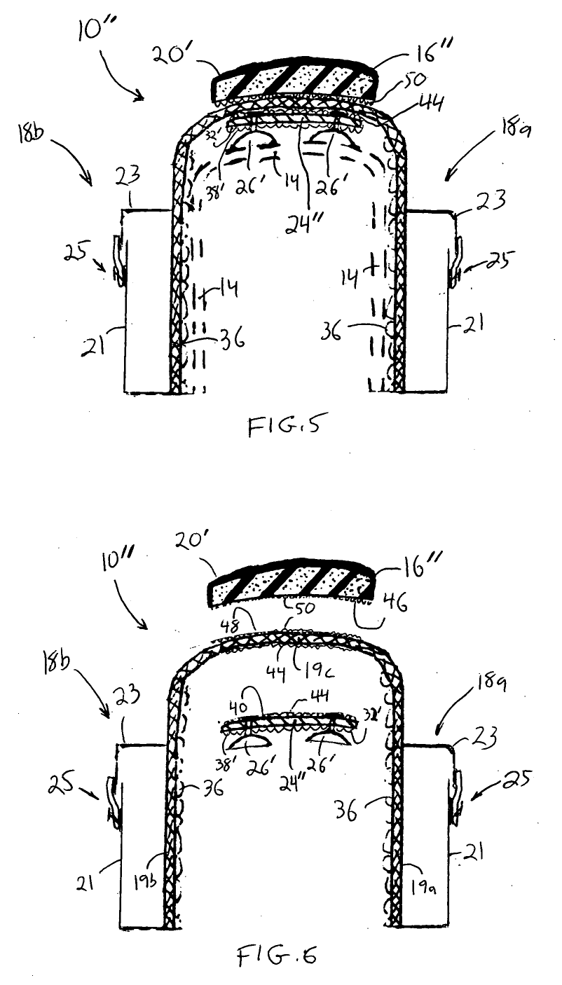

Referring to FIGS. 5 and 6, according to a further alternative embodiment of the invention, modular detachable assembly 10″ comprises seat 16″, saddlebags 18a, 18b including straps 19′ and detachable base portion 24″. Base portion 24″ provides structural support for seat pad 20′ as well as a foundation for mounting suction cups 26 thereto. Bottom surface 32′ of seat 16″ may be contoured to substantially approximate the curvature of the rear fender of the vehicle.

With further reference to FIGS. 5 and 6, base portion 24″ is releasably attached to rear fender 14 of a vehicle via suction cups 26′. Bottom surface 32′ of base portion 24″ is provided with anti-scratch layer 38′, whereas top surface 40 of the base portion is attached to bottom surface 42 of central portion 19c′ of straps 19′ via hook and loop fasteners 44. Likewise, bottom surface 46 of detachable set 16″ is attached to top surface 48 of central portion 19c′ of straps 19′ via hook and loop fasteners 50. The structure of saddlebags 18a, 18b including the straps is otherwise similar to that of the embodiment of FIGS. 1 and 2. Similar to the embodiment depicted in FIG. 4, the modular detachable assembly of FIGS. 5 and 6 may feature a base portion 24 without suction cups, wherein the base portion comprises a magnet for providing releasable attachment of the seat to the rear fender of the vehicle.

According to a further embodiment of the invention, the modular detachable assembly depicted in FIGS. 5 and 6 may be used without seat 16″. According to an additional embodiment of the invention, the seat and base portion of the modular detachable assembly of FIGS. 5 and 6 may be releasably attached to the central portion of the straps using snaps or buttons rather than hook and loop fasteners.

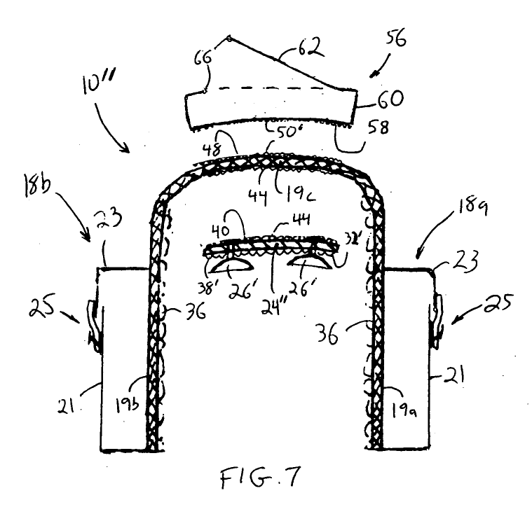

Referring to FIG. 7, the seat 16″ of FIGS. 5 and 6 may be replaced by detachable storage pack 56. Bottom surface 58 of detachable storage pack 56 is attached to top surface 48 of central portion 19c′ of straps 19′ via hook and loop fasteners 50′. Detachable storage pack 56 comprises a main compartment 60 for storing cargo and a flexible flap 62 that is attached to main compartment 60 using zipper 66. Snaps or buttons may also be employed to secure flexible flap 62 to main compartment 60. The embodiments of FIGS. 1-4 may also feature a detachable storage pack in lieu of the seat.

One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A detachable assembly to be mounted on a vehicle fender, the detachable assembly comprising:
a seat configured to be releasably mounted on the fender; and
a pair of saddlebags attached to the seat;
wherein the seat comprises a seat pad, a base portion and one or more suction cups mounted to the base portion for releasably attaching the seat to the fender.

2. The detachable assembly of claim 1, wherein the seat is constructed of a moldable plastic or molded closed-cell, foam-like, material.

3. The detachable assembly of claim 1, wherein the base portion is disposed within the seat such that the suction cups extend through apertures within a bottom surface of the seat.

4. The detachable assembly of claim 1, wherein a bottom surface of the seat is contoured to substantially approximate the curvature of the fender.

5. The detachable assembly of claim 1, wherein each saddlebag comprises a main compartment for storing cargo and a flexible flap that is releasably attached to main compartment.

6. The detachable assembly of claim 1, wherein the saddlebags are attached to the seat via straps such that hang down from the seat on either side of the fender.

7. The detachable assembly of claim 6, wherein the saddlebags are substantially parallel to each other.

8. The detachable assembly of claim 7, wherein the straps are formed from a single piece of material comprising a central portion and a pair of end portions.

9. The detachable assembly of claim 8, wherein each end portion is attached to a saddlebag.

10. The detachable assembly of claim 8, wherein the central portion is disposed within the seat between the seat pad and the base portion.

11. The detachable assembly of claim 10, wherein the central portion is fixedly attached to the seat to maintain correct alignment of the saddlebags with the seat.

12. The detachable assembly of claim 7, wherein an inside surface of the straps is coated with a non-abrasive, anti-scratch layer.

13. The detachable assembly of claim 12, wherein the non-abrasive, anti-scratch layer comprises neoprene.

14. The detachable assembly of claim 1, wherein a bottom surface of the seat is coated with a non-abrasive, anti-scratch layer.

15. The detachable assembly of claim 14, wherein the non-abrasive, anti-scratch layer comprises neoprene.

16. The detachable assembly of claim 1, wherein the suction cups 2 comprise double suction cups having an inner cup disposed within the center of an outer cup, for providing improved gripping capabilities.

17. A modular detachable assembly to be mounted on a vehicle fender, the modular detachable assembly comprising:
a base portion configured to be releasably mounted on the fender;
a saddlebag assembly releasably attached to the base portion; and
a seat releasably attached to the base portion.

18. The modular detachable assembly of claim 17, wherein the base portion is releasably attached to the fender using one or more suction cups.

19. The modular detachable assembly of claim 17, wherein the base portion is releasably attached to the fender using one or more magnets.

20. The modular detachable assembly of claim 17, wherein the saddlebag assembly comprises a pair of saddlebags and a strap having a central portion and a pair of end portions.

21. The modular detachable assembly of claim 20, wherein the central portion of the strap is releasably attached to the base portion.

22. The modular detachable assembly of claim 21, wherein the central portion of the strap is releasably attached to the base portion using hook and loop fasteners.

23. The modular detachable assembly of claim 20, wherein the seat is releasably attached to the central portion of the strap.

24. The modular detachable assembly of claim 23, wherein the seat is releasably attached to the central portion of the strap using hook and loop fasteners.

25. The detachable assembly of claim 17, wherein an inside surface of the strap is coated with a non-abrasive, anti-scratch layer.

26. The detachable assembly of claim 17, wherein a bottom surface of the base portion is coated with a non-abrasive, anti-scratch layer.

27. The detachable assembly of claim 17, wherein the base portion comprises a magnet for providing releasable attachment of the seat to the fender.

28. A detachable assembly to be mounted on a vehicle fender, the detachable assembly comprising:
a base portion configured to be releasably mounted on the fender; and
a saddlebag assembly releasably attached to the base portion.

29. The modular detachable assembly of claim 28, wherein the base portion is releasably attached to the fender using one or more suction cups.

30. The modular detachable assembly of claim 28, wherein the saddlebag assembly comprises a pair of saddlebags and a strap having a central portion and a pair of end portions.

31. The modular detachable assembly of claim 30, wherein the central portion of the strap is releasably attached to the base portion.

32. The modular detachable assembly of claim 31, wherein the central portion of the strap is fixedly attached to the base portion.

33. The modular detachable assembly of claim 31, wherein the central portion of the strap is releasably attached to the base portion using hook and loop fasteners.

34. The detachable assembly of claim 28, wherein the base portion comprises a magnet for providing releasable attachment of the base portion to the fender.

35. A modular detachable assembly to be mounted on a vehicle fender, the modular detachable assembly comprising:
a base portion configured to be releasably mounted on the fender;
a saddlebag assembly releasably attached to the base portion; and
a storage pack releasably attached to the base portion.

36. The modular detachable assembly of claim 35, wherein the base portion is releasably attached to the fender using one or more suction cups.

37. The modular detachable assembly of claim 35, wherein the saddlebag assembly comprises a pair of saddlebags and a strap having a central portion and a pair of end portions.

38. The modular detachable assembly of claim 37, wherein the central portion of the strap is releasably attached to the base portion using hook and loop fasteners.

39. The modular detachable assembly of claim 37, wherein the storage pack is releasably attached to the central portion of the strap using hook and loop fasteners.

40. The detachable assembly of claim 35, wherein the base portion comprises a magnet for providing releasable attachment to the fender.
